(19) United States
(12) Patent Application Publication
(10) Pub. No.: US 2026/0147261 A1
(43) Pub. Date: May 28, 2026

(54) ILLUMINATION SYSTEM AND PROJECTION APPARATUS

(71) Applicant: Coretronic Corporation, Hsin-Chu (TW)

(72) Inventors: Yu-Hsiang Deng, Hsin-Chu (TW); Jui Chang, Hsin-Chu (TW)

(73) Assignee: Coretronic Corporation, Hsin-Chu (TW)

(21) Appl. No.: 19/387,689

(22) Filed: Nov. 13, 2025

(30) Foreign Application Priority Data
Nov. 22, 2024 (CN) 202411679027.8

(51) Int. Cl. G03B 21/20

(52) U.S. Cl. CPC G03B 21/2013; G03B 21/2066; G03B 21/208

(57) ABSTRACT

An illumination system is provided. A projection apparatus includes the illumination system. The illumination system includes a light source module and a first dichroic mirror. The light source module includes a first light source and a second light source. The first light source and the second light source respectively provide a first color light, a second color light, and a third color light. The first dichroic mirror is disposed on transmission paths of the first color light, the second color light, and the third color light. The first dichroic mirror allows the first color light and the second color light to transmit along a first direction and allows the third color light to transmit along a second direction. The first direction is perpendicular to the second direction. The disclosure achieves a reduction of the size of the projection apparatus and enhances the color saturation of the projected image.

### CROSS-REFERENCE TO RELATED APPLICATION

This application claims the priority benefit of China application serial no. 202411679027.8 filed on November 22, 2024. The entirety of the above-mentioned patent application is hereby incorporated by reference herein and made a part of this specification.

### BACKGROUND

### Technical Field

The disclosure relates to an optical system and an optical apparatus, and particularly relates to an illumination system and a projection apparatus applying the illumination system.

### Description of Related Art

A projection apparatus is a display apparatus used for generating large-area images, and continues to advance with technological development and innovation. The imaging principle of the projection apparatus is to convert an illumination light beam generated by an illumination system into an image light beam via a light valve, and then project the image light beam through a projection lens onto a projection target (e.g., a screen or wall) to form a projected image. To achieve color display effects, the illumination system may use laser diodes (or light emitting diodes) of different emission colors, or a monochrome (e.g., blue light) laser combined with wavelength conversion components as the illumination light source.

Generally, the optical components in a projection apparatus are usually arranged on the same horizontal plane (e.g., the bottom of the case). Thus, a larger space is occupied in the horizontal dimension. To reduce the occupied space in the horizontal dimension, some current projection apparatuses configure certain optical components (e.g., wavelength conversion components) at different heights. However, to guide the light beam to optical components at different heights, additional reflecting mirrors need to be added, making it difficult to reduce the overall size of the projection apparatus and increasing costs.

The information disclosed in this Background section is only for enhancement of understanding of the background of the described technology and therefore it may contain information that does not form the prior art that is already known to a person of ordinary skill in the art. Further, the information disclosed in the Background section does not mean that one or more problems to be resolved by one or more embodiments of the disclosure was acknowledged by a person of ordinary skill in the art.

### SUMMARY

The disclosure provides an illumination system and a projection apparatus, which occupy less space in size and enhance the color saturation of the projected image. In addition, the wavelength conversion wheel of the projection apparatus may have improved stability and reduced vibration and noise during rotation.

The other objectives and advantages of the disclosure may be further understood from the descriptive features disclosed in the disclosure.

In order to achieve one or a part or all of the above purposes or other purposes, an embodiment of the disclosure provides an illumination system. The illumination system includes a light source module and a first dichroic mirror. The light source module includes a first light source and a second light source, each configured to provide a first color light, a second color light, and a third color light. The first dichroic mirror is disposed on transmission paths of the first color light, the second color light, and the third color light, the first dichroic mirror is configured to allow the first color light and the second color light to transmit along a first direction and to allow the third color light to transmit along a second direction, where the first direction is perpendicular to the second direction.

In an embodiment of the disclosure, the first light source and the second light source of the illumination system each include a first color light source, a second color light source, and a third color light source, the first color light source is configured to emit the first color light, the second color light source is configured to emit the second color light, and the third color light source is configured to emit the third color light.

In an embodiment of the disclosure, the first dichroic mirror of the illumination system has a first area and a second area, the first area is configured to allow the second color light from the first light source to pass through and reflect the third color light from the first light source and reflect the first color light from the second light source, and the second area is configured to allow the first color light from the first light source and the third color light from the second light source to pass through and reflect the second color light from the second light source.

In an embodiment of the disclosure, the illumination system further includes a second dichroic mirror and a wavelength conversion wheel. The second dichroic mirror is disposed on a transmission path of the third color light from the light source module, the wavelength conversion wheel is disposed on a transmission path of the third color light from the second dichroic mirror, and the wavelength conversion wheel includes a substrate, the substrate is provided with a wavelength conversion area and a reflection area, the wavelength conversion area is disposed on a surface of the substrate, the substrate is configured to drive the wavelength conversion area and the reflection area to rotate about a rotation axis, allowing the wavelength conversion area to convert the third color light into a fourth color light and reflect the fourth color light to the second dichroic mirror within a first time interval, and allowing the reflection area to reflect the third color light to the second dichroic mirror within a second time interval. The second dichroic mirror is configured to allow the third color light to pass through and reflect the fourth color light.

In an embodiment of the disclosure, a case bottom surface is configured to support the weight of the illumination system, and the surface of the substrate is parallel to the case bottom surface.

In an embodiment of the disclosure, the rotation axis is parallel to a gravity direction.

In an embodiment of the disclosure, the illumination system further includes a first reflecting mirror, a second reflecting mirror, and a third reflecting mirror, disposed on a transmission path of the third color light from the first dichroic mirror. The third color light from the first dichroic mirror and transmitting along the second direction is reflected by the first reflecting mirror and then transmits along a third direction perpendicular to the gravity direction to the second reflecting mirror, the third color light is reflected by the second reflecting mirror and then transmits along the first direction to the third reflecting mirror, and the third color light is reflected by the third reflecting mirror and then transmits along the gravity direction to the second dichroic mirror.

In an embodiment of the disclosure, the illumination system further includes a third dichroic mirror and a fourth reflecting mirror. The third dichroic mirror is disposed on transmission paths of the first color light and the second color light from the first dichroic mirror, and the fourth reflecting mirror is disposed on a transmission path of the third color light from the second dichroic mirror. The third color light from the second dichroic mirror and transmitting along the second direction is reflected by the fourth reflecting mirror and then transmits along an opposite direction of the third direction to the third dichroic mirror, and the third dichroic mirror is configured to allow the first color light and the second color light to pass through and reflect the third color light.

In an embodiment of the disclosure, the illumination system further includes a fourth dichroic mirror and a fifth reflecting mirror. The fourth dichroic mirror is disposed on a transmission path of the fourth color light from the second dichroic mirror, the first color light, the second color light, and the third color light from the third dichroic mirror and transmitting along the first direction are reflected by the fifth reflecting mirror and then transmit along the third direction to the fourth dichroic mirror, and the fourth dichroic mirror is configured to allow the fourth color light to pass through and reflect the first color light, the second color light, and the third color light.

In an embodiment of the disclosure, the illumination system further includes a first light-homogenizing element, disposed on transmission paths of the first color light, the second color light, and the third color light from the third dichroic mirror and located between the third dichroic mirror and the fifth reflecting mirror.

In an embodiment of the disclosure, the illumination system further includes a second light-homogenizing element, disposed on transmission paths of the first color light, the second color light, the third color light, and the fourth color light from the fourth dichroic mirror. The second light-homogenizing element allows the first color light, the second color light, the third color light, and the fourth color light to pass through.

In order to achieve one or part or all of the above purposes or other purposes, an embodiment of disclosure proposes a projection apparatus. The projection apparatus includes an illumination system, a light valve, and a projection lens. The illumination system is configured to provide an illumination light beam. The light valve is disposed on a transmission path of the illumination light beam and is configured to convert the illumination light beam into an image light beam. The projection lens is disposed on a transmission path of the image light beam and is configured to project the image light beam out of the projection apparatus. The illumination system includes a light source module and a first dichroic mirror. The light source module includes a first light source and a second light source, each configured to provide a first color light, a second color light, and a third color light. The first dichroic mirror is disposed on transmission paths of the first color light, the second color light, and the third color light, the first dichroic mirror is configured to allow the first color light and the second color light to transmit along a first direction and to allow the third color light to transmit along a second direction, where the first direction is perpendicular to the second direction.

In an embodiment of the disclosure, the first light source and the second light source of the projection apparatus each include a first color light source, a second color light source, and a third color light source, the first color light source is configured to emit the first color light, the second color light source is configured to emit the second color light, and the third color light source is configured to emit the third color light.

In an embodiment of the disclosure, the first dichroic mirror of the projection apparatus has a first area and a second area, the first area is configured to allow the second color light from the first light source to pass through and reflect the third color light from the first light source and reflect the first color light from the second light source, and the second area is configured to allow the first color light from the first light source and the third color light from the second light source to pass through and reflect the second color light from the second light source.

In an embodiment of the disclosure, the projection apparatus further includes a second dichroic mirror and a wavelength conversion wheel. The second dichroic mirror is disposed on a transmission path of the third color light from the light source module, the wavelength conversion wheel is disposed on a transmission path of the third color light from the second dichroic mirror, and the wavelength conversion wheel includes a substrate, the substrate is provided with a wavelength conversion area and a reflection area, the wavelength conversion area is disposed on a surface of the substrate, the substrate is configured to drive the wavelength conversion area and the reflection area to rotate about a rotation axis, allowing the wavelength conversion area to convert the third color light into a fourth color light and reflect the fourth color light to the second dichroic mirror within a first time interval, and allowing the reflection area to reflect the third color light to the second dichroic mirror within a second time interval. The second dichroic mirror is configured to allow the third color light to pass through and reflect the fourth color light.

In an embodiment of the disclosure, the projection apparatus further includes a case. The surface of the substrate is parallel to a case bottom surface of the case, and the case bottom surface is configured to support a weight of the illumination system.

In an embodiment of the disclosure, the projection apparatus further includes a prism group, disposed on a transmission path of the illumination light beam from the illumination system and configured to project the illumination light beam onto the light valve.

In an embodiment of the disclosure, the light valve of the projection apparatus has a light modulation surface parallel to the second direction and the light modulation surface is perpendicular to the case bottom surface, the light modulation surface has a first edge and a second edge perpendicular to each other, the first edge is parallel to the case bottom surface, and an orthographic projection of an optical path of the illumination light beam from the prism group on the light modulation surface is not parallel to the first edge and the second edge.

Based on the above, in the illumination system and the projection apparatus of an embodiment of the disclosure, the first color light and the second color light from the light source module are transmitted along the first direction perpendicular to the gravity direction after leaving the first dichroic mirror, while the third color light from the light source module is transmitted along the opposite direction of the gravity direction (second direction) after leaving the first dichroic mirror. The third color light is transmitted to the wavelength conversion wheel via the second dichroic mirror after leaving the first dichroic mirror. Through the configuration of the first dichroic mirror, the third color light may be transmitted along the gravity direction. Thus, multiple optical components disposed on the optical path of the third color light between the first dichroic mirror and the wavelength conversion wheel may be respectively disposed at different positions along the gravity direction, which helps reduce the overall size of the illumination system and the projection apparatus.

Other objectives, features and advantages of the present invention will be further understood from the further technological features disclosed by the embodiments of the present invention wherein there are shown and described preferred embodiments of this invention, simply by way of illustration of modes best suited to carry out the invention.

### BRIEF DESCRIPTION OF THE DRAWINGS

FIG. 1 is a schematic top view of a projection apparatus according to an embodiment of the disclosure.

FIG. 2 is a schematic side view of a partial area of the projection apparatus of FIG. 1.

FIG. 3 is an enlarged schematic view of the first dichroic mirror and the light source module of FIG. 2.

FIG. 4 is a schematic diagram of the light emission timing sequence of different color lights from the light source module of FIG. 2 within one frame period.

FIG. 5A and FIG. 5B are schematic views of the wavelength conversion wheel in FIG. 1 and FIG. 2.

FIG. 6 is a distribution diagram of transmittance versus wavelength of the fourth dichroic mirror of FIG. 1.

FIG. 7 is a schematic side view of the light valve of FIG. 1.

### DESCRIPTION OF THE EMBODIMENTS

In the following detailed description of the preferred embodiments, reference is made to the accompanying drawings which form a part hereof, and in which are shown by way of illustration specific embodiments in which the invention may be practiced. In this regard, directional terminology, such as “top,” “bottom,” “front,” “back,” etc., is used with reference to the orientation of the Figure(s) being described. The components of the present invention can be positioned in a number of different orientations. As such, the directional terminology is used for purposes of illustration and is in no way limiting. On the other hand, the drawings are only schematic and the sizes of components may be exaggerated for clarity. It is to be understood that other embodiments may be utilized and structural changes may be made without departing from the scope of the present invention. Also, it is to be understood that the phraseology and terminology used herein are for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” and “mounted” and variations thereof herein are used broadly and encompass direct and indirect connections, couplings, and mountings. Similarly, the terms “facing,” “faces” and variations thereof herein are used broadly and encompass direct and indirect facing, and “adjacent to” and variations thereof herein are used broadly and encompass directly and indirectly “adjacent to”. Therefore, the description of “A” component facing “B” component herein may contain the situations that “A” component directly faces “B” component or one or more additional components are between “A” component and “B” component. Also, the description of “A” component “adjacent to” “B” component herein may contain the situations that “A” component is directly “adjacent to” “B” component or one or more additional components are between “A” component and “B” component. Unless limited otherwise, the terms “connected,” “coupled,” and “mounted,” and variations thereof herein are used broadly and encompass direct and indirect connections, couplings, and mountings. Accordingly, the drawings and descriptions will be regarded as illustrative in nature and not as restrictive.

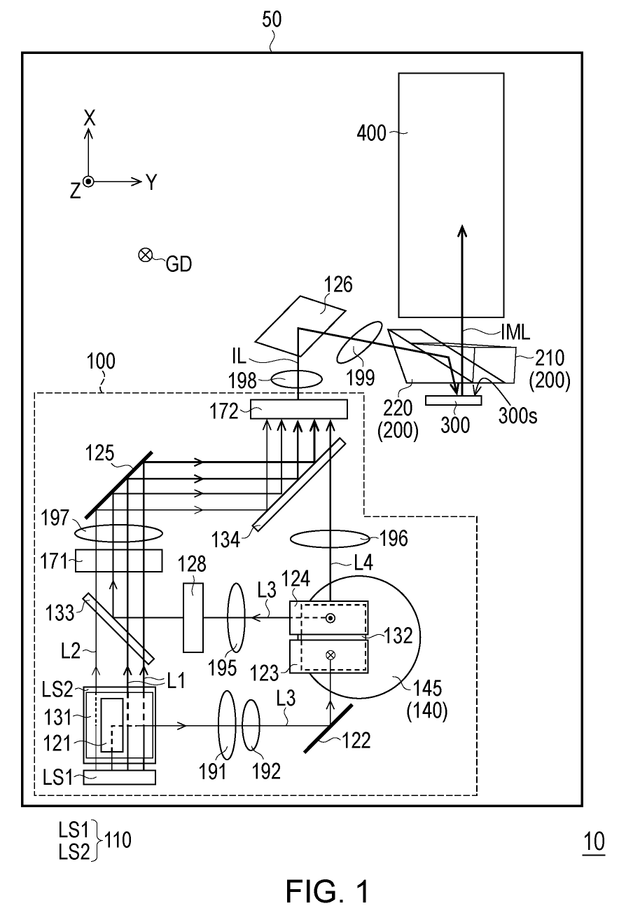

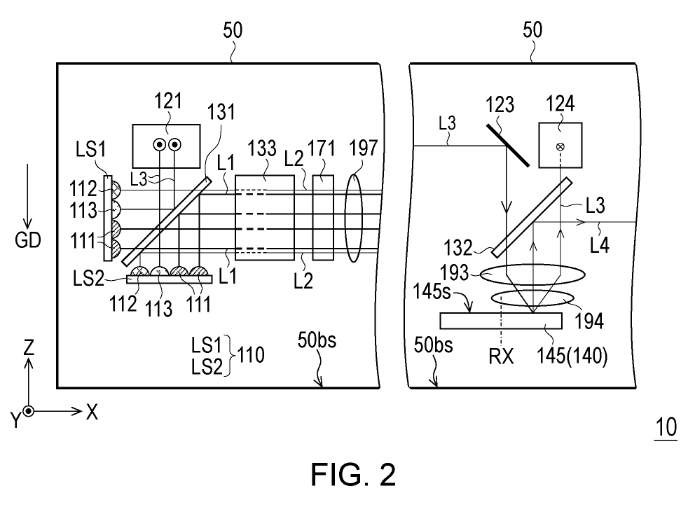

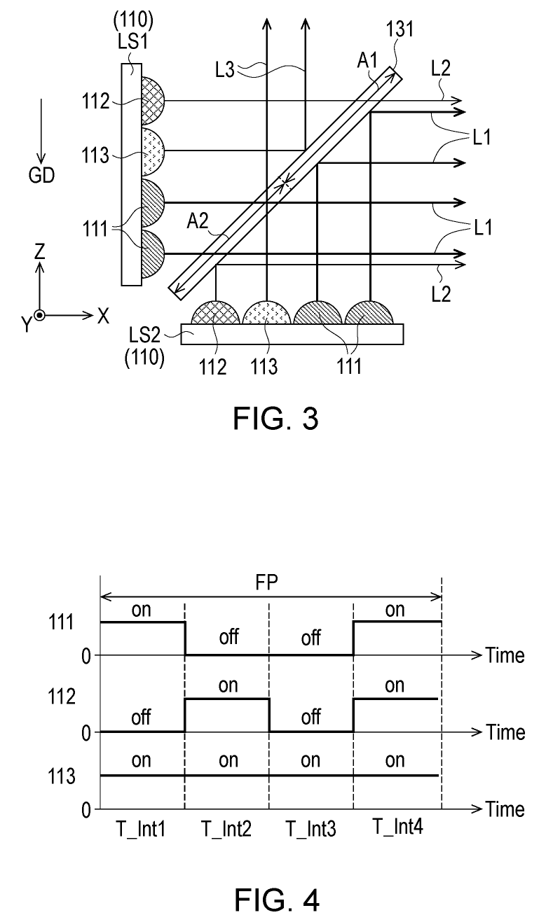

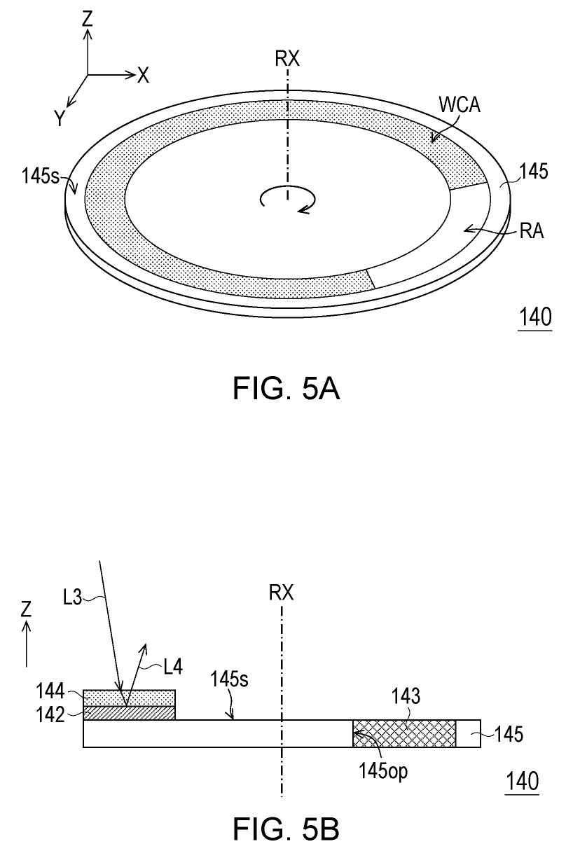

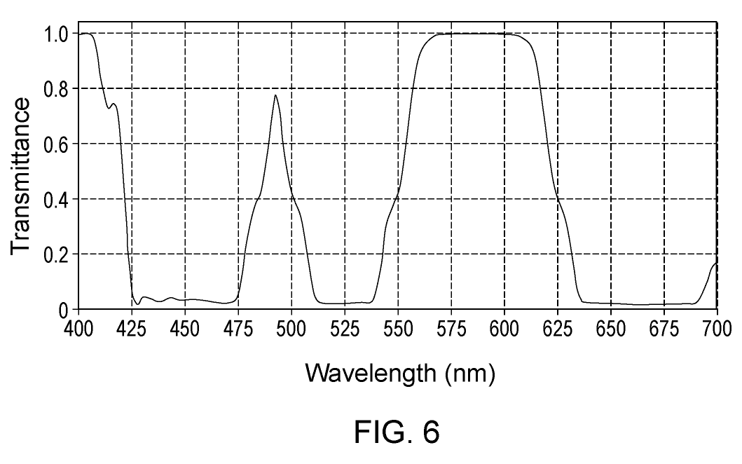

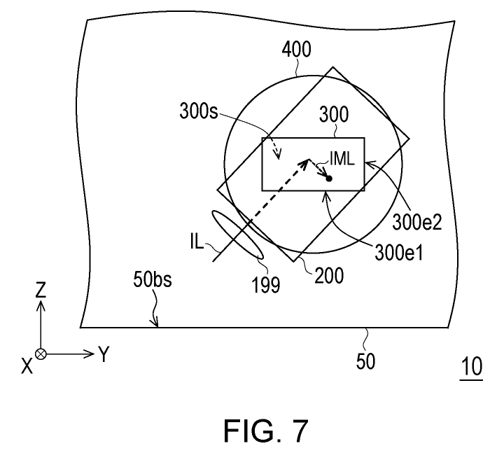

FIG. 1 is a schematic top view of a projection apparatus according to an embodiment of the disclosure. FIG. 2 is a schematic side view of a partial area of the projection apparatus of FIG. 1. FIG. 3 is an enlarged schematic view of the first dichroic mirror and the light source module of FIG. 2. FIG. 4 is a schematic diagram of the light emission timing sequence of different color lights from the light source module of FIG. 2 within one frame period. FIG. 5A and FIG. 5B are schematic views of the wavelength conversion wheel in FIG. 1 and FIG. 2. FIG. 6 is a distribution diagram of transmittance versus wavelength of the fourth dichroic mirror of FIG. 1. FIG. 7 is a schematic side view of the light valve of FIG. 1. For clarity, the illustration of lens 193 and lens 194 in FIG. 2 is omitted from FIG. 1.

Referring to FIG. 1 and FIG. 2, the projection apparatus 10 includes a case 50 and an illumination system 100. The illumination system 100 is disposed within the case 50. The illumination system 100 is configured to provide an illumination light beam IL, and the illumination system 100 includes a light source module 110 and a first dichroic mirror 131. The light source module 110 is configured to provide a first color light L1, a second color light L2, and a third color light L3. The first dichroic mirror 131 is disposed on a transmission path of the first color light L1, the second color light L2, and the third color light L3 from the light source module 110.

In this embodiment, the first color light L1 may be red light, the second color light L2 may be green light, and the third color light L3 may be blue light, but is not limited thereto. For example, the light source module 110 includes a first light source LS1 and a second light source LS2. Each of the first light source LS1 and the second light source LS2 may include a first color light source 111 for providing the first color light L1, a second color light source 112 for providing the second color light L2, and a third color light source 113 for providing the third color light L3. In this embodiment, each of the first color light source 111, the second color light source 112, and the third color light source 113 may be a laser diode (LD), but is not limited thereto. In other embodiments, the color light source of the light source module may be a light emitting diode (LED).

It is noted that in this embodiment, the number of installations for each of the first color light source 111, the second color light source 112, and the third color light source 113 is exemplarily demonstrated as two, one, and one respectively, which does not indicate that the disclosure is limited to this configuration. In other embodiments, the number of color light sources of different colors may be adjusted according to different application requirements or optical designs. In this embodiment, the third color light source 113 may be disposed between the first color light source 111 and the second color light source 112, allowing the third color light L3 from the third color light source 113 to be concentrated and illuminated on the middle area of the first dichroic mirror 131.

Referring to FIG. 2 and FIG. 3, in this embodiment, the arrangement plane of the first color light source 111, the second color light source 112, and the third color light source 113 of the first light source LS1 may be parallel to a gravity direction GD, while the arrangement plane of the first color light source 111, the second color light source 112, and the third color light source 113 of the second light source LS2 may be perpendicular to the gravity direction GD. Furthermore, the case 50 has a case bottom surface 50bs, and the case bottom surface 50bs is perpendicular to the gravity direction GD. In other words, the arrangement plane of the first color light source 111, the second color light source 112, and the third color light source 113 of the first light source LS1 may be perpendicular to the case bottom surface 50bs, while the arrangement plane of the first color light source 111, the second color light source 112, and the third color light source 113 of the second light source LS2 may be parallel to the case bottom surface 50bs. The first color light L1, the second color light L2, and the third color light L3 emitted from the first light source LS1 are incident on the first dichroic mirror 131 along a first direction (e.g., X direction) perpendicular to the gravity direction GD. The first color light L1, the second color light L2, and the third color light L3 emitted from the second light source LS2 are incident on the first dichroic mirror 131 along an opposite direction of the gravity direction GD (e.g., Z direction, where Z direction is the second direction). The first direction is the X direction, the second direction is the Z direction, and the third direction is the Y direction.

More specifically, the first color light L1 and the second color light L2 of the light source module 110 are transmitted along the first direction (e.g., X direction) perpendicular to the gravity direction GD after leaving the first dichroic mirror 131, while the third color light L3 of the light source module 110 is transmitted along the opposite direction of the gravity direction GD (e.g., Z direction) after leaving the first dichroic mirror 131. In other words, the first dichroic mirror 131 allows the first color light L1 and the second color light L2 to be transmitted along the first direction (X direction), and allows the third color light L3 to be transmitted along the second direction (Z direction), where the first direction is perpendicular to the second direction.

In this embodiment, the first dichroic mirror 131 has a first area A1 and a second area A2. The first area A1 is disposed corresponding to the second color light source 112 and the third color light source 113 of the first light source LS1, and the first color light source 111 of the second light source LS2. The second area A2 is disposed corresponding to the first color light source 111 of the first light source LS1, and the second color light source 112 and the third color light source 113 of the second light source LS2. It is noted that the first area A1 is adapted for allowing the second color light L2 from the first light source LS1 to pass through, and for reflecting the third color light L3 from the first light source LS1 and reflecting the first color light L1 from the second light source LS2. The second area A2 is adapted for allowing the first color light L1 from the first light source LS1 and the third color light L3 from the second light source LS2 to pass through, and for reflecting the second color light L2 from the second light source LS2. Specifically, the first color light L1 is red light, the second color light L2 is green light, and the third color light L3 is blue light. The first area A1 of the first dichroic mirror 131 allows green light to transmit, and reflects red light and blue light. The second area A2 of the first dichroic mirror 131 allows red light and blue light to transmit, and reflects green light. It is worth mentioning that the first dichroic mirror 131 allows the first color light L1 and the second color light L2 to be transmitted along the first direction (X direction), and allows the third color light L3 to be transmitted along the opposite direction of the gravity direction GD (Z direction).

The illumination system 100 further includes a second dichroic mirror 132 and a wavelength conversion wheel 140. The second dichroic mirror 132 is disposed on the transmission path of the third color light L3 from the light source module 110. The wavelength conversion wheel 140 is disposed on the transmission path of the third color light L3 from the second dichroic mirror 132. Referring to FIG. 2, FIG. 5A and FIG. 5B, the wavelength conversion wheel 140 includes a substrate 145, and the substrate 145 is provided with a wavelength conversion area WCA and a reflection area RA. The wavelength conversion area WCA is disposed on a surface 145s of the substrate 145. A motor drives the substrate 145 to rotate, and the substrate 145 is adapted to drive the wavelength conversion area WCA and the reflection area RA to rotate about the rotation axis RX, so that the wavelength conversion area WCA converts the third color light L3 into the fourth color light L4 and reflects the fourth color light L4 to the second dichroic mirror 132 within one time interval (first time interval), and the reflection area RA reflects the third color light L3 to the second dichroic mirror 132 within another time interval (second time interval). The second dichroic mirror 132 is adapted for allowing the third color light L3 to pass through and reflecting the fourth color light L4. In this embodiment, the fourth color light L4 may be yellow light, but is not limited thereto.

In this embodiment, the wavelength conversion wheel 140 may further include a reflection layer 142 and a wavelength conversion layer 144 sequentially stacked on the surface 145s. The wavelength conversion layer 144 defines the wavelength conversion area WCA, and is configured to convert the third color light L3 into the fourth color light L4. The reflection layer 142 may be a white diffuse reflection layer, configured to diffusely reflect the fourth color light L4 to the second dichroic mirror 132. The surface 145s is defined as the incident surface of the substrate 145 facing the third color light L3. It is noted that in the normal direction of the surface 145s (e.g., Z direction), the substrate 145 has an opening 145op, and a specular reflection member 143 is disposed within the opening 145op of the substrate 145. The specular reflection member 143 defines the reflection area RA. The specular reflection member 143 is configured to reflect the third color light L3 to the second dichroic mirror 132. More specifically, after the wavelength conversion layer 144 is excited by the third color light L3 to generate the fourth color light L4, the fourth color light L4 may be reflected by the reflection layer 142 and transmitted through the wavelength conversion layer 144 to the second dichroic mirror 132.

Referring to FIG. 2 to FIG. 4, within one frame period FP of the projection apparatus 10, the light output from the light source module 110 of the illumination system 100 may be divided into four time intervals. For example, the first color light source 111 is enabled to emit the first color light L1 (e.g., red light) during the time interval T_Int1 and the time interval T_Int4, and is disabled during other time intervals. The second color light source 112 is enabled to emit the second color light L2 (e.g., green light) during the time interval T_Int2 and the time interval T_Int4, and is disabled during other time intervals. The third color light source 113 is enabled to emit the third color light L3 (e.g., blue light) during all four time intervals T_Int1 to T_Int4. In the four time intervals T_Int1 to T_Int4, the illumination light beam IL includes at least one of red light, green light, blue light, and yellow light.

From another perspective, during the time interval T_Int1, the light source module 110, in addition to emitting the first color light L1, also emits the third color light L3 to the wavelength conversion area WCA of the wavelength conversion wheel 140 to excite the fourth color light L4 (e.g., yellow light). During the time interval T_Int2, the light source module 110, in addition to emitting the second color light L2, also emits the third color light L3 to the wavelength conversion area WCA of the wavelength conversion wheel 140 to excite the fourth color light L4. During the time interval T_Int3, the light source module 110 only emits the third color light L3, and the third color light L3 is incident on the reflection area RA of the wavelength conversion wheel 140 via the second dichroic mirror 132. During the time interval T_Int4, the light source module 110 simultaneously emits the first color light L1, the second color light L2, and the third color light L3, and the third color light L3 is incident on the wavelength conversion area WCA of the wavelength conversion wheel 140 via the second dichroic mirror 132 to excite the fourth color light L4.

In other words, the illumination system 100 simultaneously emits the first color light L1 and the fourth color light L4 during the time interval T_Int1. The illumination system 100 simultaneously emits the second color light L2 and the fourth color light L4 during the time interval T_Int2. The illumination system 100 emits the third color light L3 during the time interval T_Int3. The illumination system 100 simultaneously emits the first color light L1, the second color light L2, and the fourth color light L4 during the time interval T_Int4. More specifically, during the time interval T_Int1, the time interval T_Int2, and the time interval T_Int4, the fourth color light L4 may serve as a supplementary color light for the first color light L1 and the second color light L2, to achieve color saturation of the projected image.

However, the disclosure is not limited thereto. In other embodiments, the first color light source 111 and the second color light source 112 may be enabled to simultaneously emit the first color light L1 and the second color light L2 during the time interval T_Int1, the time interval T_Int2, and the time interval T_Int4, and may be disabled only during the time interval T_Int3.

Referring to FIG. 1 and FIG. 2, it is particularly noted that the case 50 has a case bottom surface 50bs for supporting the weight of the illumination system 100, and the surface 145s of the substrate 145 of the wavelength conversion wheel 140 is parallel to the case bottom surface 50bs of the case 50. More specifically, the rotation axis RX of the substrate 145 is parallel to the gravity direction GD (which is the -Z direction). In other words, the surface 145s of the substrate 145 is perpendicular to the gravity direction GD. Since the surface 145s of the substrate 145 is parallel to the case bottom surface 50bs of the case 50 of the projection apparatus 10, the stability of the wavelength conversion wheel 140 during rotation may be improved, which helps reduce vibration and noise generated during the rotation process. As a result, the stability of the optical path of the illumination system 100 may be significantly enhanced.

First, it is to be noted that through the arrangement of the first dichroic mirror 131, the third color light L3 may be transmitted along the gravity direction GD. Thus, multiple optical components disposed on the optical path of the third color light L3 between the first dichroic mirror 131 and the wavelength conversion wheel 140 may be respectively disposed at different positions along the gravity direction GD, which helps reduce the overall size of the illumination system 100 and the projection apparatus 10.

For example, the illumination system 100 may further include a first reflecting mirror 121, a second reflecting mirror 122, and a third reflecting mirror 123, respectively disposed on the transmission path of the third color light L3 from the first dichroic mirror 131. The third color light L3 from the first dichroic mirror 131 and along the opposite direction of the gravity direction GD (e.g., Z direction) is reflected by the first reflecting mirror 121 and then transmitted along a third direction (e.g., Y direction) perpendicular to the gravity direction GD to the second reflecting mirror 122. The third color light L3 is reflected by the second reflecting mirror 122 and transmitted along the first direction (X direction) to the third reflecting mirror 123, and then reflected by the third reflecting mirror 123 and transmitted along the gravity direction GD (-Z direction, opposite to the second direction) to the second dichroic mirror 132.

The illumination system 100 may further include a third dichroic mirror 133 and a fourth reflecting mirror 124. The third dichroic mirror 133 is disposed on the transmission paths of the first color light L1 and the second color light L2 from the first dichroic mirror 131, and the third color light L3 from the second dichroic mirror 132. The fourth reflecting mirror 124 is disposed on the transmission path of the third color light L3 from the second dichroic mirror 132. The third color light L3 from the second dichroic mirror 132 and transmitted along the opposite direction of the gravity direction GD (e.g., Z direction) is reflected by the fourth reflecting mirror 124 and then transmitted along the opposite direction of the third direction (-Y direction) to the third dichroic mirror 133. In this embodiment, the third dichroic mirror 133 is adapted for allowing the first color light L1 and the second color light L2 to pass through and reflecting the third color light L3.

The illumination system 100 may further include a fourth dichroic mirror 134 and a fifth reflecting mirror 125. The fourth dichroic mirror 134 is disposed on the transmission paths of the first color light L1, the second color light L2, and the third color light L3 from the third dichroic mirror 133, and the fourth color light L4 from the second dichroic mirror 132. The first color light L1, the second color light L2, and the third color light L3 from the third dichroic mirror 133 and transmitted along the first direction (X direction) are reflected by the fifth reflecting mirror 125 and then transmitted along the third direction (Y direction) to the fourth dichroic mirror 134. Referring to FIG. 6, in this embodiment, the fourth dichroic mirror 134 has a transmittance less than 0.1 for light beams with wavelength ranges between 425nm and 475nm, 510nm and 530nm, and 630nm and 680nm, and has a transmittance close to 1 for light beams with wavelength range between 550nm and 620nm. That is, the fourth dichroic mirror 134 is adapted for allowing yellow light (i.e., the fourth color light L4) to pass through and reflecting red light (i.e., the first color light L1), green light (i.e., the second color light L2), and blue light (i.e., the third color light L3).

Referring to FIG. 1 and FIG. 2, in this embodiment, the illumination system 100 may further include a first light-homogenizing element 171 and a second light-homogenizing element 172. The first light-homogenizing element 171 is disposed on the transmission paths of the first color light L1, the second color light L2, and the third color light L3 from the third dichroic mirror 133, and is located between the third dichroic mirror 133 and the fifth reflecting mirror 125. The second light-homogenizing element 172 is disposed on the transmission paths of the first color light L1, the second color light L2, the third color light L3, and the fourth color light L4 from the fourth dichroic mirror 134. The first color light L1, the second color light L2, the third color light L3, and the fourth color light L4 form an illumination light beam IL after transmitting through the second light-homogenizing element 172. The illumination light beam IL includes at least one of the first color light L1, the second color light L2, the third color light L3, and the fourth color light L4. The first light-homogenizing element 171 and the second light-homogenizing element 172 may each be, for example, a lens array, an integration rod, or other optical components with light homogenizing effects, but are not limited thereto. In this embodiment, the first light-homogenizing element 171 may be, for example, a lens array, and the first light-homogenizing element 171 is configured to destroy the characteristics of laser light and solve the problem of laser speckle. The second light-homogenizing element 172 is configured to adjust the light shapes of the first color light L1, the second color light L2, the third color light L3, and the fourth color light L4 to match the shape of the light-incident surface of the light valve 300 (e.g., rectangular).

In order to reduce the overall size of the projection apparatus 10, the aforementioned multiple optical components may be disposed in spaces at different distances relative to the case bottom surface 50bs. For example, in this embodiment, the distance between the wavelength conversion wheel 140 and the case bottom surface 50bs is smaller than the distance between the first reflecting mirror 121, the second reflecting mirror 122, and the third reflecting mirror 123 and the case bottom surface 50bs.

Through the above-mentioned configuration relationship, the optical path distance between the light source module 110 and the wavelength conversion wheel 140, as well as the number of components disposed on the optical path, may be effectively reduced, and the wavelength conversion efficiency of the wavelength conversion wheel 140 for the third color light L3 may be improved.

In this embodiment, multiple lenses may also be disposed on the optical path of the illumination system 100. For example, a lens 191 and a lens 192 may be disposed on the transmission path of the third color light L3 between the light source module 110 and the second reflecting mirror 122, a lens 193 and a lens 194 may be disposed on the transmission path of the third color light L3 between the second dichroic mirror 132 and the wavelength conversion wheel 140, a lens 195 may be disposed on the transmission path of the third color light L3 between the fourth reflecting mirror 124 and the third dichroic mirror 133, a lens 196 may be disposed on the transmission path of the fourth color light L4 between the second dichroic mirror 132 and the fourth dichroic mirror 134, and a lens 197 may be disposed on the transmission paths of the first color light L1, the second color light L2, and the third color light L3 between the third dichroic mirror 133 and the fifth reflecting mirror 125, but the disclosure is not limited thereto.

On the other hand, a guiding mirror 128 may also be disposed on the transmission path of the third color light L3 between the fourth reflecting mirror 124 and the third dichroic mirror 133. Since the distance between the fourth reflecting mirror 124 and the case bottom surface 50bs is greater than the distance between the third dichroic mirror 133 and the case bottom surface 50bs, the guiding mirror 128 may allow the third color light L3 to be transmitted between optical components at different heights.

Furthermore, the projection apparatus 10 further includes a prism group 200, a light valve 300, and a projection lens 400. The prism group 200 is disposed on the transmission path of the illumination light beam IL from the illumination system 100, and is configured to project the illumination light beam IL onto the light valve 300. In this embodiment, the prism group 200 may be a total internal reflection prism group (TIR prism group) composed of two prisms 210 and 220.

Referring to FIG. 7, the light valve 300 is disposed on the transmission path of the illumination light beam IL and is configured to convert the illumination light beam IL into an image light beam IML. In this embodiment, the light valve 300 has a light modulation surface 300s parallel to the gravity direction GD, and the light modulation surface 300s is perpendicular to the case bottom surface 50bs. The light modulation surface 300s has a first edge 300e1 and a second edge 300e2 perpendicular to each other. The first edge 300e1 is parallel to the case bottom surface 50bs. Through the guidance of the prism group 200, the orthographic projection of the illumination light beam IL on the light modulation surface 300s is not parallel to the first edge 300e1 and the second edge 300e2, and through the guidance of the prism group 200, the orthographic projection of the illumination light beam IL on the light modulation surface 300s is also not perpendicular to the first edge 300e1 and the second edge 300e2.

The light valve 300 may be, for example, a reflective light modulator such as a liquid crystal on silicon panel (LCoS panel), a digital micro-mirror device (DMD), etc., but is not limited thereto. Regarding the method by which the light valve 300 converts the illumination light beam IL from the illumination system 100 into the image light beam IML, sufficient instructions, recommendations, and implementation explanations for its detailed steps and implementation methods may be obtained from common knowledge in the relevant technical field. Thus, it is not further elaborated herein.

The projection lens 400 is disposed on the transmission path of the image light beam IML, and is configured to project the image light beam IML out of the projection apparatus 10 onto a projection target (not shown), such as a screen or a wall. The projection lens 400 includes, for example, a combination of one or more optical lenses with diopter, such as various combinations of non-planar lenses such as biconcave lenses, biconvex lenses, meniscus lenses, convex-concave lenses, plano-convex lenses, and plano-concave lenses. In one embodiment, the projection lens 400 may also include optical reflecting mirrors to project the image light beam IML from the light valve 300 onto the projection target by reflection. The disclosure does not limit the form and type of the projection lens 400.

For example, in this embodiment, along the transmission path of the illumination light beam IL between the illumination system 100 and the prism group 200, a lens 198, a sixth reflecting mirror 126, and a lens 199 may be sequentially disposed along the transmission direction, but is not limited thereto.

In summary, in the illumination system and the projection apparatus of an embodiment of the disclosure, the first color light and the second color light from the light source module are transmitted along the first direction perpendicular to the gravity direction after leaving the first dichroic mirror, while the third color light from the light source module is transmitted along the opposite direction of the gravity direction (second direction) after leaving the first dichroic mirror. The third color light is transmitted to the wavelength conversion wheel via the second dichroic mirror after leaving the first dichroic mirror. Through the configuration of the first dichroic mirror, the first color light and the second color light are allowed to transmit along the first direction, and the third color light is allowed to transmit along the second direction, where the first direction is perpendicular to the second direction. Thus, multiple optical components disposed on the optical path of the third color light between the first dichroic mirror and the wavelength conversion wheel may be respectively disposed at different positions along the gravity direction, which helps reduce the overall size of the illumination system and the projection apparatus. Moreover, the projection apparatus of the disclosure may enhance the color saturation of the projected image, and the wavelength conversion wheel of the projection apparatus may have improved stability and reduced vibration and noise during rotation.

The foregoing description of the preferred embodiments of the invention has been presented for purposes of illustration and description. It is not intended to be exhaustive or to limit the invention to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to best explain the principles of the invention and its best mode practical application, thereby to enable persons skilled in the art to understand the invention for various embodiments and with various modifications as are suited to the particular use or implementation contemplated. It is intended that the scope of the invention be defined by the claims appended hereto and their equivalents in which all terms are meant in their broadest reasonable sense unless otherwise indicated. Therefore, the term “the invention”, “the present invention” or the like does not necessarily limit the claim scope to a specific embodiment, and the reference to particularly preferred exemplary embodiments of the invention does not imply a limitation on the invention, and no such limitation is to be inferred. The invention is limited only by the spirit and scope of the appended claims. The use of “at least one of...and...” thereof herein may include “one or more of the items contained in the list”. For example, the use of “at least one of A and B” thereof herein may include only A, or only B, or A and B. Similarly, the use of “at least one of A, B, and C” thereof herein may include only A, or only B, or only C, or any combination of A, B, and C. Moreover, these claims may refer to use “first”, “second”, etc. following with noun or element. Such terms should be understood as a nomenclature and should not be construed as giving the limitation on the number of the elements modified by such nomenclature unless specific number has been given. The abstract of the disclosure is provided to comply with the rules requiring an abstract, which will allow a searcher to quickly ascertain the subject matter of the technical disclosure of any patent issued from this disclosure. It is submitted with the understanding that it will not be used to interpret or limit the scope or meaning of the claims. Any advantages and benefits described may not apply to all embodiments of the invention. It should be appreciated that variations may be made in the embodiments described by persons skilled in the art without departing from the scope of the present invention as defined by the following claims. Moreover, no element and component in the present disclosure is intended to be dedicated to the public regardless of whether the element or component is explicitly recited in the following claims.

What is claimed is:

1. An illumination system, comprising:
a light source module and a first dichroic mirror, wherein the light source module comprises a first light source and a second light source; each of the first light source and the second light source is configured to provide a first color light, a second color light, and a third color light, and
the first dichroic mirror is disposed on transmission paths of the first color light, the second color light, and the third color light, the first dichroic mirror is configured to allow the first color light and the second color light to transmit along a first direction and to allow the third color light to transmit along a second direction, where the first direction is perpendicular to the second direction.

2. The illumination system according to claim 1, wherein the first light source and the second light source each comprise a first color light source, a second color light source, and a third color light source, the first color light source is configured to emit the first color light, the second color light source is configured to emit the second color light, and the third color light source is configured to emit the third color light.

3. The illumination system according to claim 1, wherein the first dichroic mirror has a first area and a second area, the first area is configured to allow the second color light from the first light source to pass through and reflect the third color light from the first light source and reflect the first color light from the second light source, and the second area is configured to allow the first color light from the first light source and the third color light from the second light source to pass through and reflect the second color light from the second light source.

4. The illumination system according to claim 3, further comprising a second dichroic mirror and a wavelength conversion wheel, wherein the second dichroic mirror is disposed on a transmission path of the third color light from the light source module, the wavelength conversion wheel is disposed on a transmission path of the third color light from the second dichroic mirror, and the wavelength conversion wheel comprises a substrate, the substrate is provided with a wavelength conversion area and a reflection area, the wavelength conversion area is disposed on a surface of the substrate, the substrate is configured to drive the wavelength conversion area and the reflection area to rotate about a rotation axis, allowing the wavelength conversion area to convert the third color light into a fourth color light and reflect the fourth color light to the second dichroic mirror within a first time interval, and allowing the reflection area to reflect the third color light to the second dichroic mirror within a second time interval, wherein the second dichroic mirror is configured to allow the third color light to pass through and reflect the fourth color light.

5. The illumination system according to claim 4, wherein a case bottom surface is configured to support a weight of the illumination system, and the surface of the substrate is parallel to the case bottom surface.

6. The illumination system according to claim 4, wherein the rotation axis is parallel to a gravity direction.

7. The illumination system according to claim 6, further comprising a first reflecting mirror, a second reflecting mirror, and a third reflecting mirror, disposed on a transmission path of the third color light from the first dichroic mirror, wherein the third color light from the first dichroic mirror and transmitting along the second direction is reflected by the first reflecting mirror and then transmits along a third direction perpendicular to the gravity direction to the second reflecting mirror, the third color light is reflected by the second reflecting mirror and then transmits along the first direction to the third reflecting mirror, and the third color light is reflected by the third reflecting mirror and then transmits along the gravity direction to the second dichroic mirror.

8. The illumination system according to claim 7, further comprising a third dichroic mirror and a fourth reflecting mirror, wherein the third dichroic mirror is disposed on transmission paths of the first color light and the second color light from the first dichroic mirror, and the fourth reflecting mirror is disposed on a transmission path of the third color light from the second dichroic mirror, wherein the third color light from the second dichroic mirror and transmitting along the second direction is reflected by the fourth reflecting mirror and then transmits along an opposite direction of the third direction to the third dichroic mirror, and the third dichroic mirror is configured to allow the first color light and the second color light to pass through and reflect the third color light.

9. The illumination system according to claim 8, further comprising a fourth dichroic mirror and a fifth reflecting mirror, wherein the fourth dichroic mirror is disposed on a transmission path of the fourth color light from the second dichroic mirror, the first color light, the second color light, and the third color light from the third dichroic mirror and transmitting along the first direction are reflected by the fifth reflecting mirror and then transmit along the third direction to the fourth dichroic mirror, and the fourth dichroic mirror is configured to allow the fourth color light to pass through and reflect the first color light, the second color light, and the third color light.

10. The illumination system according to claim 9, further comprising a first light-homogenizing element, disposed on transmission paths of the first color light, the second color light, and the third color light from the third dichroic mirror and located between the third dichroic mirror and the fifth reflecting mirror.

11. The illumination system according to claim 10, further comprising a second light-homogenizing element, disposed on transmission paths of the first color light, the second color light, the third color light, and the fourth color light from the fourth dichroic mirror, wherein the second light-homogenizing element allows the first color light, the second color light, the third color light, and the fourth color light to pass through.

12. A projection apparatus, comprising:
an illumination system, configured to provide an illumination light beam and comprising a light source module and a first dichroic mirror, wherein
the light source module comprises a first light source and a second light source; each of the first light source and the second light source is configured to provide a first color light, a second color light, and a third color light, and
the first dichroic mirror is disposed on transmission paths of the first color light, the second color light, and the third color light, the first dichroic mirror is configured to allow the first color light and the second color light to transmit along a first direction and to allow the third color light to transmit along a second direction, where the first direction is perpendicular to the second direction;
a light valve, disposed on a transmission path of the illumination light beam and configured to convert the illumination light beam into an image light beam; and
a projection lens, disposed on a transmission path of the image light beam and configured to project the image light beam out of the projection apparatus.

13. The projection apparatus according to claim 12, wherein the first light source and the second light source each comprise a first color light source, a second color light source, and a third color light source, the first color light source is configured to emit the first color light, the second color light source is configured to emit the second color light, and the third color light source is configured to emit the third color light.

14. The projection apparatus according to claim 12, wherein the first dichroic mirror has a first area and a second area, the first area is configured to allow the second color light from the first light source to pass through and reflect the third color light from the first light source and reflect the first color light from the second light source, and the second area is configured to allow the first color light from the first light source and the third color light from the second light source to pass through and reflect the second color light from the second light source.

15. The projection apparatus according to claim 14, further comprising a second dichroic mirror and a wavelength conversion wheel, wherein the second dichroic mirror is disposed on a transmission path of the third color light from the light source module, the wavelength conversion wheel is disposed on a transmission path of the third color light from the second dichroic mirror, and the wavelength conversion wheel comprises a substrate, the substrate is provided with a wavelength conversion area and a reflection area, the wavelength conversion area is disposed on a surface of the substrate, the substrate is configured to drive the wavelength conversion area and the reflection area to rotate about a rotation axis, allowing the wavelength conversion area to convert the third color light into a fourth color light and reflect the fourth color light to the second dichroic mirror within a first time interval, and allowing the reflection area to reflect the third color light to the second dichroic mirror within a second time interval, wherein the second dichroic mirror is configured to allow the third color light to pass through and reflect the fourth color light.

16. The projection apparatus according to claim 15, further comprising a case, wherein the surface of the substrate is parallel to a case bottom surface of the case, and the case bottom surface is configured to support a weight of the illumination system.

17. The projection apparatus according to claim 16, further comprising a prism group, disposed on a transmission path of the illumination light beam from the illumination system and configured to project the illumination light beam onto the light valve.

18. The projection apparatus according to claim 17, wherein the light valve has a light modulation surface parallel to the second direction and the light modulation surface is perpendicular to the case bottom surface, the light modulation surface has a first edge and a second edge perpendicular to each other, the first edge is parallel to the case bottom surface, and an orthographic projection of an optical path of the illumination light beam from the prism group on the light modulation surface is not parallel to the first edge and the second edge.
